(19) United States
(12) Patent Application Publication
(10) Pub. No.: US 2026/0050532 A1
(43) Pub. Date: Feb. 19, 2026

(54) Intelligent Optimization of Software Performance Through Generative Artificial Intelligence

(71) Applicant: SAP SE, Walldorf (DE)

(72) Inventors: Krishnan Harihara Subramanian, Bangalore (IN); Dinesh Bhandarkar, Bangalore (IN)

(21) Appl. No.: 18/808,823

(22) Filed: Aug. 19, 2024

(51) Int. Cl. G06F 11/34; G06F 8/41; G06F 11/36

(52) U.S. Cl. CPC G06F 11/3466; G06F 8/443; G06F 11/3616; G06F 11/3688

(57) ABSTRACT

Arrangements for optimizing software performance through generative artificial intelligence are provided. Execution data associated with a user interacting with an application programming interface through a user interface on a computing device may be received. Trace data based on the execution data may be generated. The trace data may indicate that a performance of an application is degraded. One or more performance prompts specifying program behavior may be generated. Application source code and the performance prompts may be sent to an artificial intelligence engine for performing key performance indicator driven code analysis. The one or more performance prompts may have been executed in the artificial intelligence engine for pretraining a large language model. Optimized source code may be received from the artificial intelligence engine. Performance testing may be executed on the optimized source code. An action may be performed to address the performance of the application.

### TECHNICAL FIELD

The subject matter described herein relates generally to data processing and more specifically to optimizing software performance through generative artificial intelligence.

### BACKGROUND

Optimizing software performance and eliminating performance transgressions is a time-consuming, error-prone, and inefficient process. For example, during third-party integration via an application programming interface, it is often difficult to pinpoint the cause of delays or other performance issues. It may be difficult to implement software integration in an effective manner that ensures a smooth transition and operational efficiency.

### SUMMARY

Methods, systems, and articles of manufacture, including computer program products, are provided for optimizing software performance through generative artificial intelligence. In one aspect, there is provided a system including at least one processor and at least one memory. The at least one memory can store instructions that cause operations when executed by the at least one processor. The operations may include: receiving execution data associated with a user interacting with an application programming interface through a user interface on a computing device; generating trace data based on the execution data, wherein the trace data indicates that a performance of an application is degraded; generating one or more performance prompts specifying program behavior; sending application source code and the performance prompts to an artificial intelligence engine for performing key performance indicator driven code analysis, the one or more performance prompts having been executed in the artificial intelligence engine for pretraining a large language model; receiving, from the artificial intelligence engine, optimized source code based on the artificial intelligence engine performing the key performance indicator driven code analysis; executing performance testing on the optimized source code; and performing an action to address the performance of the application.

In some variations, one or more of the features disclosed herein including the following features can optionally be included in any feasible combination. In some variations, the application programming interface may be associated with an entity manipulation language application.

In some variations, the application programming interface may be associated with a simple object access protocol.

In some variations, the trace data may include one or more of: a database trace and a transaction analysis trace.

In some variations, generating the trace data may include generating one or more graphs corresponding to a performance of the application.

In some variations, executing performance testing on the optimized source code may include comparing values of one or more key performance indicators to corresponding thresholds.

In some variations, the key performance indicator driven code analysis may include analyzing performance metrics including one or more of: response time, error rate, central processing unit usage, and memory usage.

In some variations, the large language model comprises ChatGPT.

In another aspect, there is provided a method for optimizing software performance through generative artificial intelligence. The method may include: receiving execution data associated with a user interacting with an application programming interface through a user interface on a computing device; generating trace data based on the execution data, wherein the trace data indicates that a performance of an application is degraded; generating one or more performance prompts specifying program behavior; sending application source code and the performance prompts to an artificial intelligence engine for performing key performance indicator driven code analysis, the one or more performance prompts having been executed in the artificial intelligence engine for pretraining a large language model; receiving, from the artificial intelligence engine, optimized source code based on the artificial intelligence engine performing the key performance indicator driven code analysis; executing performance testing on the optimized source code; and performing an action to address the performance of the application.

In some variations, one or more of the features disclosed herein including the following features can optionally be included in any feasible combination. In some variations, the application programming interface may be associated with an entity manipulation language application.

In some variations, the application programming interface may be associated with a simple object access protocol.

In some variations, the trace data may include one or more of: a database trace and a transaction analysis trace.

In some variations, generating the trace data may include generating one or more graphs corresponding to a performance of the application.

In some variations, executing performance testing on the optimized source code may include comparing values of one or more key performance indicators to corresponding thresholds.

In some variations, the key performance indicator driven code analysis may include analyzing performance metrics including one or more of: response time, error rate, central processing unit usage, and memory usage.

In some variations, the large language model comprises ChatGPT.

In another aspect, there is provided a computer program product that includes a non-transitory computer readable medium. The non-transitory computer readable medium may store instructions that cause operations when executed by at least one processor. The operations may include: receiving execution data associated with a user interacting with an application programming interface through a user interface on a computing device; generating trace data based on the execution data, wherein the trace data indicates that a performance of an application is degraded; generating one or more performance prompts specifying program behavior; sending application source code and the performance prompts to an artificial intelligence engine for performing key performance indicator driven code analysis, the one or more performance prompts having been executed in the artificial intelligence engine for pretraining a large language model; receiving, from the artificial intelligence engine, optimized source code based on the artificial intelligence engine performing the key performance indicator driven code analysis; executing performance testing on the optimized source code; and performing an action to address the performance of the application.

In some variations, one or more of the features disclosed herein including the following features can optionally be included in any feasible combination. In some variations, the application programming interface may be associated with an entity manipulation language application.

In some variations, the application programming interface may be associated with a simple object access protocol.

In some variations, the trace data may include one or more of: a database trace and a transaction analysis trace.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an illustrative computing environment for intelligent performance optimization in accordance with some example embodiments;

FIG. 2 depicts a flowchart illustrating a process for intelligent performance optimization in accordance with some example embodiments;

FIG. 3A depicts a dependency tree in accordance with some example embodiments;

FIG. 3B depicts a dependency graph in accordance with some example embodiments;

FIG. 4 depicts a core data services view in accordance with some example embodiments;

FIG. 5 depicts a prompt output associated with a process for intelligent performance optimization in accordance with some example embodiments; and

FIG. 6 depicts a block diagram illustrating a computing system, in accordance with some example embodiments.

When practical, similar reference numbers denote similar structures, features, or elements.

### DETAILED DESCRIPTION

Aspects of the disclosure provide a technical solution that addresses problems associated with software performance issues. Aspects of the disclosure monitors, evaluates, and identifies performance issues for simple object access protocol (SOAP) and representational state transfer (REST) application programming interfaces (APIs) associated with enterprise resource planning (ERP) software packages. For example, aspects of the disclosure monitors, evaluates, and identifies performance issues for SOAP API and RAP EML (RESTful application programming model entity manipulation language) applications through generative artificial intelligence to improve operational efficiency and user experience. Further aspects of the disclosure provide automated identification of key software performance metrics. In some aspects, performance issues may be identified well upfront before a software product reaches users. Software incidents may be eliminated and user experience may be improved. Advantageously, aspects of the disclosure may reduce the need for rework of an application later in its lifecycle, improve customer satisfaction and usage, lead to focus more on providing customer centric features, lower resources costs, and reduce possibilities of shutdown. These and various other arrangements will be discussed more fully below.

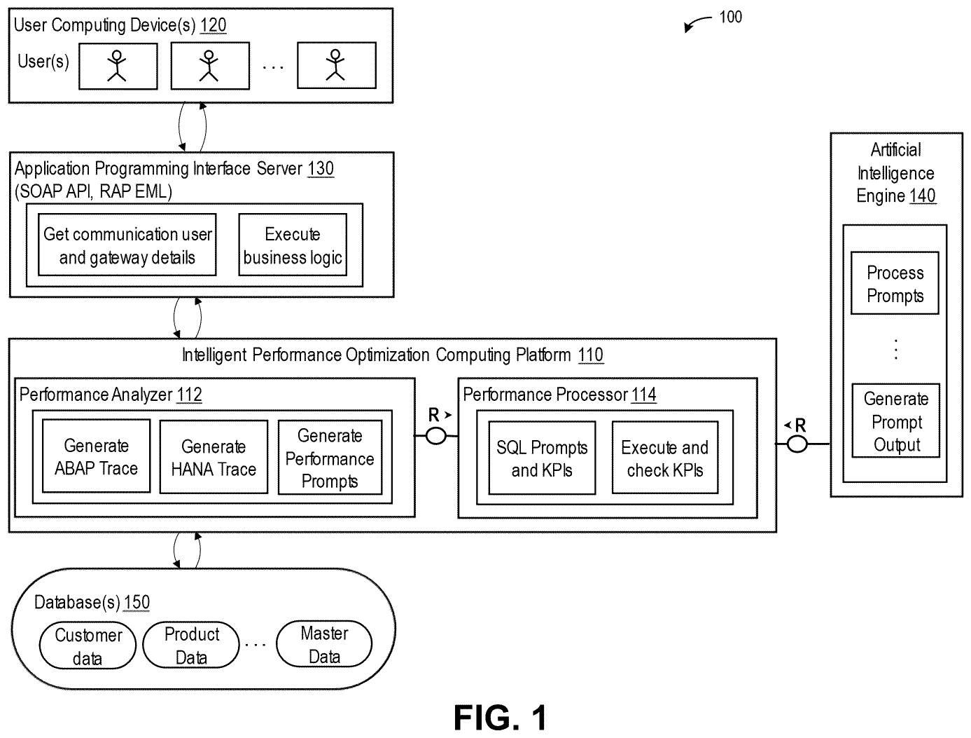

FIG. 1 depicts an illustrative computing environment 100 for intelligent performance optimization in accordance with some example embodiments. Referring to FIG. 1, the computing environment 100 may include one or more computing devices and/or other computing systems. For example, computing environment 100 may include an intelligent performance optimization computing platform 110, user computing device(s) 120 (of one or more users), an application programming interface server 130, an artificial intelligence engine 140, and database(s) 150. Intelligent performance optimization computing platform 110 may include one or more computing devices configured to perform one or more of the functions described herein. As discussed in further detail below, intelligent performance optimization computing platform 110 may employ a generative artificial intelligence engine that processes performance prompts generated by intelligent performance optimization computing platform 110 and generate prompt outputs for identifying key software performance metrics and resolving performance issues.

User computing device(s) 120 may be a processor-based device including, for example, a smartphone, a desktop computer, tablet computer, a wearable apparatus, a virtual assistant, an Internet-of-Things (IoT) appliance, and/or the like.

Application programming interface server 130 may include one or more computing devices that allows users to build, manage, and deploy APIs (e.g., REST APIs, SOAP APIs).

Artificial intelligence engine 140 may be a generative artificial intelligence engine. Artificial intelligence engine may include large language models (LLMS) for performing generative artificial intelligence operations. A large language model includes a type of machine learning model that may perform a variety of natural language processing tasks including generating and classifying text, answering questions in a conversational manner, and translating text.

Database(s) 150 may include, for example, a relational database, an in-memory database, a graph database, a key-value store, a document store, and/or the like. In some examples, the intelligent performance optimization computing platform 110 may maintain (e.g., store) various types of data, including static and nonstatic data (e.g., customer data, product data, master data, sales order data, transactional data, partner data, and/or the like) in one or more database(s) 150 coupled with the intelligent performance optimization computing platform 110. Database(s) 150 may have a data quality set for various database sizes (e.g., different size categories may have different lower limits/minimum number of records). In some examples, intelligent performance optimization computing platform 110 may verify that the system under test has sufficient records before testing and updating a model. The minimum record based on different size categories helps to identify performance issues. The minimum record for a medium size category might be 10,000, the minimum record for a large size category might be 1 million, the minimum record for an even larger category might be 10 million, and the minimum record for the largest category might be 100 million. It is preferable to have sufficient data based on size categories for identifying performance issues which might otherwise get unnoticed.

In some implementations, the intelligent performance optimization computing platform 110, the user computing device(s) 120, the application programming interface server 130, the artificial intelligence engine 140, and the database(s) 150 may be communicatively coupled via a network (not shown). The network may be a wired and/or wireless network including, for example, a wide area network (WAN), local area network (LAN), a virtual local area network (VLAN), the Internet, and/or the like.

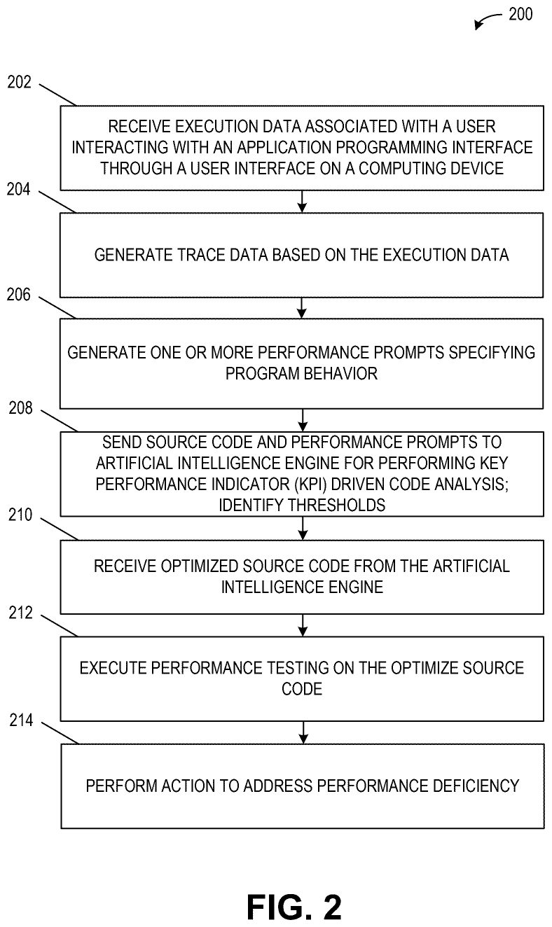

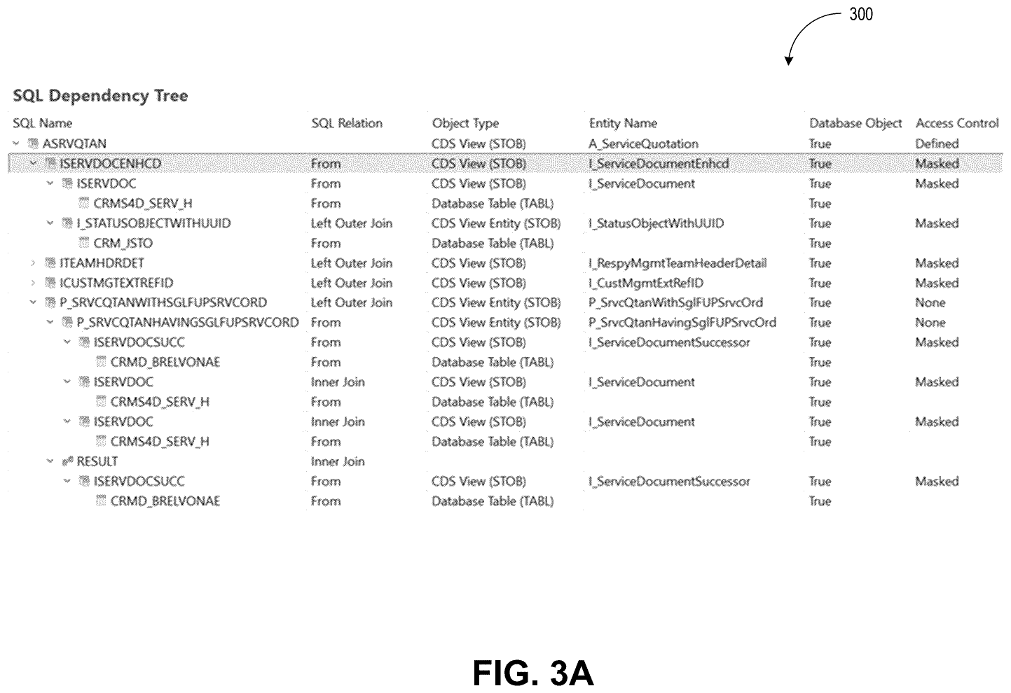

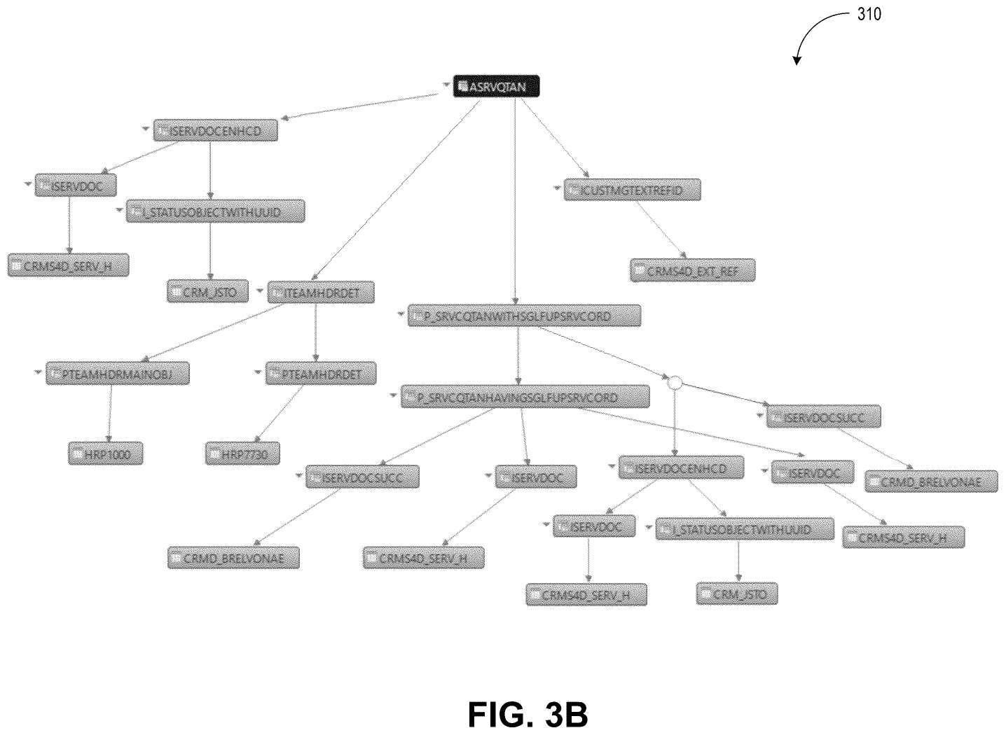

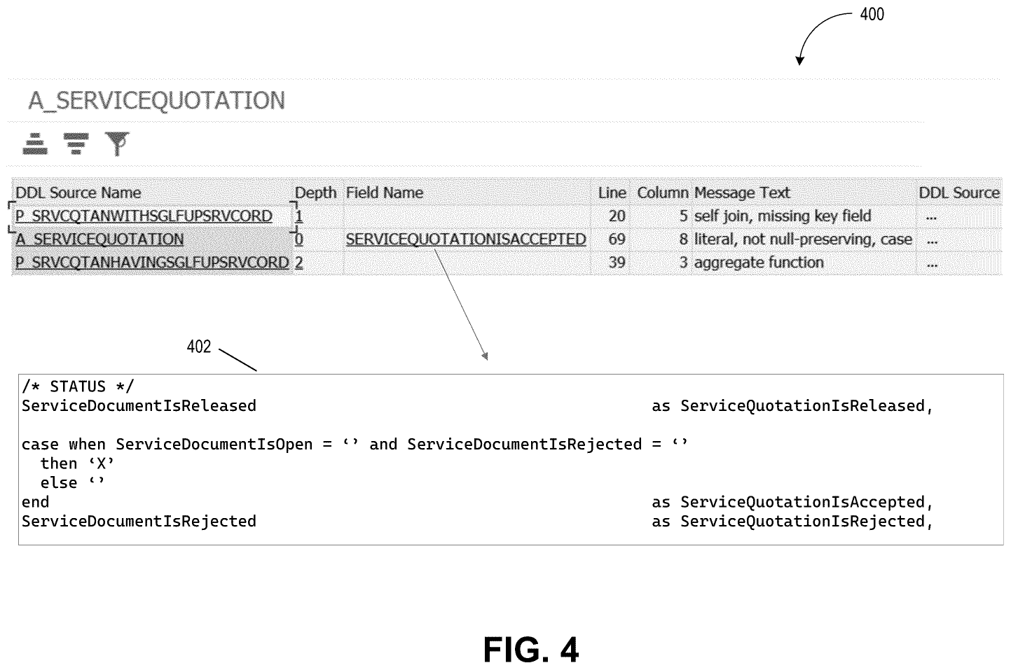

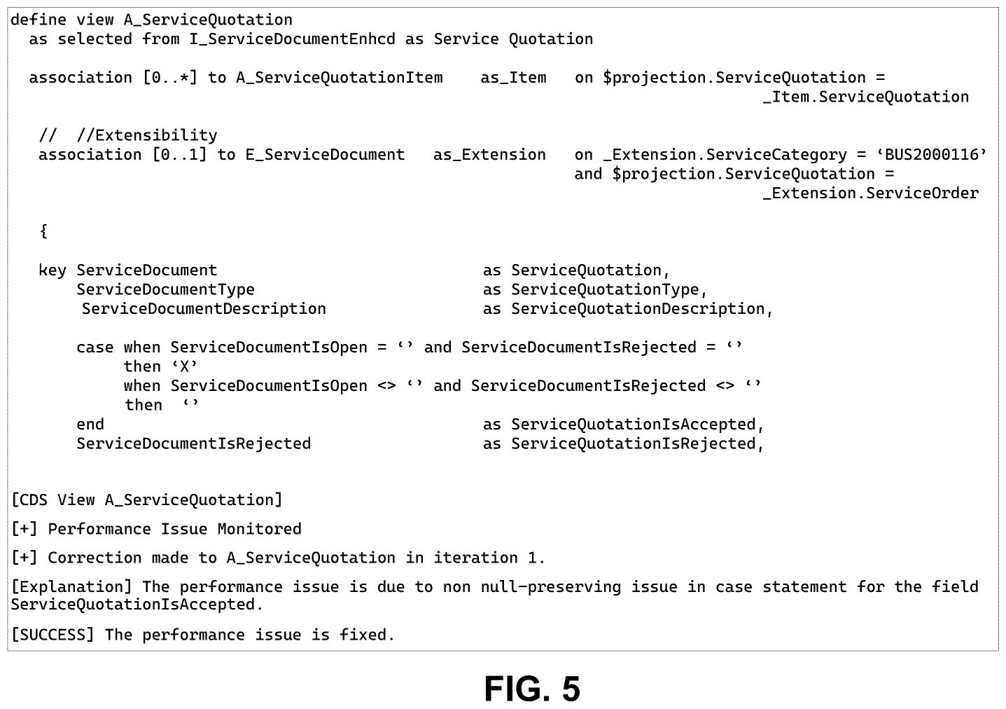

FIGS. 2 through 5 will be discussed together. FIG. 2 depicts a flowchart 200 illustrating a process for intelligent performance optimization in accordance with some example embodiments. FIG. 3A depicts a dependency tree 300 in accordance with some example embodiments. FIG. 3B depicts a dependency graph 310 in accordance with some example embodiments. FIG. 4 depicts a core data services view 400 in accordance with some example embodiments. FIG. 5 depicts a prompt output 500 associated with a process for intelligent performance optimization in accordance with some example embodiments.

At step 202, intelligent performance optimization computing platform 110 may receive execution data (e.g., executed business logic) associated with a user interacting with an application programming interface through a user interface on a computing device (e.g., through inputs and actions). In some examples, the application programming interface may be associated with an entity manipulation language (EML) application. In some examples, the application programming interface may be associated with a simple object access protocol (SOAP). In the SOAP API, for example, operations might include a user creating a transaction, a service order, a service quotation, a sales order, or the like. The user input may then be integrated via the API through a communication gateway.

The SOAP API is a standard messaging protocol that operating systems use to communicate via Hypertext Transfer Protocol (HTTP) and Extensible Markup Language (XML). SOAP APIs allow applications to interact and create, update, delete, and retrieve/read records. The ABAP RAP framework enables users to build robust and flexible applications, providing the ability to dynamically generate EML requests. EML includes syntaxes to read, modify (e.g., create, update, delete, execute actions), and commit.

In some implementations, the advanced business application programming (ABAP) programming language is used. ABAP is used for programming application servers or to program business systems. ABAP programs reside in a system database, usually in both source code and generated code. The source code can be inspected and edited. ABAP programs execute under the control of a runtime system, which is responsible for processing ABAP statements, controlling the flow logic of screens, and responding to events such as user interactions.

At step 204, intelligent performance optimization computing platform 110 may (e.g., via a logging/trace component) generate trace data based on the execution data. To generate a trace, performance configurations may be set with a monitoring user and a user under test. For example, a monitoring user may capture or otherwise take a trace of an application executed by the user under test (e.g., the user executing the API). The trace data may include a database trace (e.g., a HANA trace (high-performance analytic appliance trace)) and/or a transaction analysis/business logic trace (e.g., an ABAP trace). In some examples, the trace data may be stored in a trace file (e.g., (e.g., “.plv,” plan visualizer file). Trace files written to by a trace logging component may be analyzed and viewed. In some examples, one or more trees or graphs (e.g., structured query language (SQL) dependency trees or graphs) corresponding to a performance of the application may be generated. The SQL dependency tree may display SQL dependencies of a core data services (CDS) view on other database objects in a tree/table as shown in FIG. 3A or in a graphical map as shown in FIG. 3B, which visualizes the data model in a graph. In some aspects, the trace data may indicate that a performance of an application is degraded. For example, the trace analysis may identify long running user requests with a complex system landscape (e.g., returning execution time in microseconds), or the trace analysis may identify functional errors that have occurred during execution of a request. In some aspects, intelligent performance optimization computing platform 110 may automatically enable a trace via code. The traces may be performed automatically in the backend via the code.

Returning to FIG. 2, at step 206, intelligent performance optimization computing platform 110 may generate one or more performance prompts (e.g., instructions) specifying desired program behavior. In some examples, the one or more performance prompts may include application business application programming statements and structured query language statements.

At step 208, intelligent performance optimization computing platform 110 may send application source code and the performance prompts to an artificial intelligence engine for performing key performance indicator driven (KPI-driven) code analysis. In addition, the one or more performance prompts may include pretrained instructions that have been executed in an artificial intelligence engine (e.g., artificial intelligence engine 140) for pretraining a large language model (LLM). The large language model may include ChatGPT or other generative large language model. In this respect, FIG. 4 depicts hotspots of the issues in a core data services (CDS) view 400 in accordance with some example embodiments. The performance prompts for case statement issues might include a non null-preserving case, with case statement 402 having issue.

In some implementations, the prompts and key performance indicators (KPIs) may be provided to an artificial intelligence engine (e.g., artificial intelligence engine 140) for training. Example instructions input to the artificial intelligence engine may include:

```
  {
    “role”: “assistant”,
    “content”: “I am a Performance assistant.”
  },
  {
    “role”: “assistant”,
    “content”: “I assist with identifying and rectifying code written in CDS views,
ABAP.”
  },
  {
    “role”: “assistant”,
    “content”: “I will be able to correct code, given the source code and error
messages.”
  },
  {
    “role”: “assistant”,
    “content”: “Execution time for retrieving more than 1 record should be within 3
seconds. This is the Performance KPI.”
  },
  {
    “role”: “assistant”,
    “content”: “Retrieval of only 1 record should consume less than 200ms. This is the
Performance KPI.”
  },
  {
    “role”: “assistant”,
    “content”: “I will always return a json string with relevant data.Json string will be
surrounded by \” for keys and values. The json will be of form
{\“TYPE\”:\“CORRECTION\” / \“PASSED\” / \”FAILED\” /
\“CONVERSATION\”,\“DATA\”: \“corrected source code\” / \“reason for success or
failure\”}”
  },
  {
    “role”: “assistant”,
    “content”: “The keys and values returned json string will always be surrounded by
\””
  },
  {
    “role”: “assistant”,
    “content”: “When TYPE is CORRECTION, DATA will contain only the final
source code. It will contain the whole corrected source code and no additional
content.”
  },
  {
    “role”: “assistant”,
    “content”: “You can create new Private views or Interface views or Composite
views to fix the performance issues.”
  },
  {
    “role”: “assistant”,
    “content”: “Example response for a how are you? could be like {\“TYPE\”:
\“CONVERSATION\”,\“DATA\”: \“I am doing good\”}”
  },
  {
    “role”: “assistant”,
    “content”: “I will return only the json data.”
  },
  {
    “role”: “user”,
    “content”: “What does null reference in CDS View mean?”
  },
  {
    “role”: “assistant”,
    “content”: “{\“TYPE\”: \“CONVERSATION\”,\“DATA\”: \“In terms of tech, null
references will cause full table scan in CDS views\”}”
  }
```

These instructions in JavaScript Object Notation (JSON) format may be sent to the artificial intelligence engine 140 along with source code. The artificial intelligence engine 140 may process the prompts and generate a prompt output. The output may be sent to intelligent performance optimization computing platform 110. In this regard, FIG. 5 illustrates how the issue is fixed in the case statement 402 which had performance issue. For example, FIG. 5 shows the fixed CDS view and output with explanation provided by the large language model (e.g., ChatGPT). As shown in FIG. 5, an output prompt may include information on the performance issue being monitored and the correction being made. In addition, the output may include an explanation and indication of remediation success.

Returning to FIG. 2, at step 210, intelligent performance optimization computing platform 110 may retrieve the output. In some implementations, intelligent performance optimization computing platform 110 may receive, from the artificial intelligence engine, optimized source code based on the artificial intelligence engine performing the key performance indicator driven code analysis. The key performance indicator driven code analysis may include analyzing performance metrics including response time (e.g., response time for each click, speed of an application), error rate, central processing unit (CPU) usage, memory usage, and/or the like. Advantageously, intelligent performance optimization computing platform 110 may, using the artificial intelligence engine, check for performance issues and take proactive measures to improve and optimize performance. For example, a loop call being called many times might not be optimized, so the corresponding function module may be fed to the artificial intelligence engine 140, and the artificial intelligence engine 140 may check for the issue and perform optimizations.

At step 212, intelligent performance optimization computing platform 110 may execute performance testing on the optimized source code. For example, intelligent performance optimization computing platform 110 may re-execute a query (e.g., an SQL query) with the optimized/corrected code and verify whether the result is within threshold. For instance, intelligent performance optimization computing platform 110 may compare values of one or more key performance indicators to corresponding performance KPI thresholds. The performance KPI thresholds may include different thresholds for different user interaction step types (e.g., simple step, complex common step, complex high TCO (total cost of ownership) step). For a simple step such as reading only one record, the threshold for receiving a response might be 3000 milliseconds. For a complex step, the threshold might be 5000 milliseconds. The thresholds may be preset or dynamically determined.

In some implementations, intelligent performance optimization computing platform 110 may attempt to execute the SQL query a predetermined number of times. If not successful (e.g., after five or six attempts), intelligent performance optimization computing platform 110 may provide an output to the end user (e.g., via user computing device 120) reporting on the execution time of the SQL query that is being optimized. Additionally or alternatively, intelligent performance optimization computing platform 110 may provide information on which particular keyword, particular join statement, particular field, and/or the like is causing a performance issue. Advantageously, intelligent performance optimization computing platform 110 may automatically identify performance issues for applications, correct the source code, and provide results. At step 214, intelligent performance optimization computing platform 110 may perform an action to address the performance (e.g., a performance degradation) of the application.

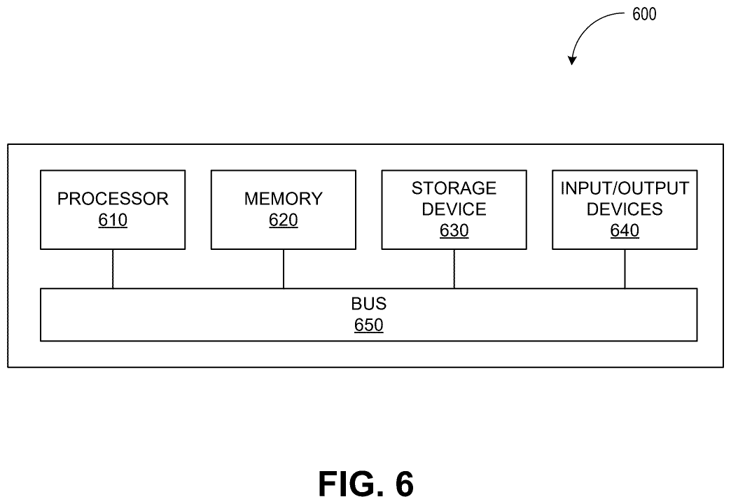

FIG. 6 depicts a block diagram illustrating a computing system 600 consistent with implementations of the current subject matter. Referring to FIGS. 1-6, the computing system 600 can be used to implement the intelligent performance optimization computing platform 110 and/or any components therein.

As shown in FIG. 6, the computing system 600 can include a processor 610, a memory 620, a storage device 630, and input/output devices 640. The processor 610, the memory 620, the storage device 630, and the input/output devices 640 can be interconnected via a system bus 650. The processor 610 is capable of processing instructions for execution within the computing system 600. Such executed instructions can implement one or more components of, for example, the intelligent performance optimization computing platform 110. In some implementations of the current subject matter, the processor 610 can be a single-threaded processor. Alternately, the processor 610 can be a multi-threaded processor. The processor 610 is capable of processing instructions stored in the memory 620 and/or on the storage device 630 to display graphical information for a user interface provided via the input/output device 640.

The memory 620 is a computer readable medium such as volatile or non-volatile that stores information within the computing system 600. The memory 620 can store data structures representing configuration object databases, for example. The storage device 630 is capable of providing persistent storage for the computing system 600. The storage device 630 can be a solid-state device, a floppy disk device, a hard disk device, an optical disk device, a tape device, and/or any other suitable persistent storage means. The input/output device 640 provides input/output operations for the computing system 600. In some implementations of the current subject matter, the input/output device 640 includes a keyboard and/or pointing device. In various implementations, the input/output device 640 includes a display unit for displaying graphical user interfaces.

According to some implementations of the current subject matter, the input/output device 640 can provide input/output operations for a network device. For example, the input/output device 640 can include Ethernet ports or other networking ports to communicate with one or more wired and/or wireless networks (e.g., a local area network (LAN), a wide area network (WAN), the Internet).

In some implementations of the current subject matter, the computing system 600 can be used to execute various interactive computer software applications that can be used for organization, analysis and/or storage of data in various (e.g., tabular) format (e.g., Microsoft Excel®, and/or any other type of software). Alternatively, the computing system 600 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 640. The user interface can be generated and presented to a user by the computing system 600 (e.g., on a computer screen monitor, etc.).

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising:
at least one processor; and
at least one memory storing instructions, which when executed by the at least one processor, result in operations comprising:
   receiving execution data associated with a user interacting with an application programming interface through a user interface on a computing device;
   generating trace data based on the execution data, wherein the trace data indicates that a performance of an application is degraded;
   generating one or more performance prompts specifying program behavior;
   sending application source code and the performance prompts to an artificial intelligence engine for performing key performance indicator driven code analysis, the one or more performance prompts having been executed in the artificial intelligence engine for pretraining a large language model;
   receiving, from the artificial intelligence engine, optimized source code based on the artificial intelligence engine performing the key performance indicator driven code analysis;
   executing performance testing on the optimized source code; and
   performing an action to address the performance of the application.

Example 2: The system of Example 1, wherein the application programming interface is associated with an entity manipulation language application.

Example 3: The system of any of Examples 1-2, wherein the application programming interface is associated with a simple object access protocol.

Example 4: The system of any of Examples 1-3, wherein the trace data comprises one or more of: a database trace and a transaction analysis trace.

Example 5: The system of any of Examples 1-4, wherein generating the trace data comprises generating one or more graphs corresponding to a performance of the application.

Example 6: The system of any of Examples 1-5, wherein executing performance testing on the optimized source code comprises comparing values of one or more key performance indicators to corresponding thresholds.

Example 7: The system of any of Examples 1-6, wherein the key performance indicator driven code analysis comprise analyzing performance metrics including one or more of: response time, error rate, central processing unit usage, and memory usage.

Example 8: The system of any of Examples 1-7, wherein the large language model comprises ChatGPT.

Example 9: A computer-implemented method comprising:
receiving execution data associated with a user interacting with an application programming interface through a user interface on a computing device;
generating trace data based on the execution data, wherein the trace data indicates that a performance of an application is degraded;
generating one or more performance prompts specifying program behavior;
sending application source code and the performance prompts to an artificial intelligence engine for performing key performance indicator driven code analysis, the one or more performance prompts having been executed in the artificial intelligence engine for pretraining a large language model;
receiving, from the artificial intelligence engine, optimized source code based on the artificial intelligence engine performing the key performance indicator driven code analysis;
executing performance testing on the optimized source code; and
performing an action to address the performance of the application.

Example 10: The computer-implemented method of Example 9, wherein the application programming interface is associated with an entity manipulation language application.

Example 11: The computer-implemented method of any of Examples 9-10, wherein the application programming interface is associated with a simple object access protocol.

Example 12: The computer-implemented method of any of Examples 9-11, wherein the trace data comprises one or more of: a database trace and a transaction analysis trace.

Example 13: The computer-implemented method of any of Examples 9-12, wherein generating the trace data comprises generating one or more graphs corresponding to a performance of the application.

Example 14: The computer-implemented method of any of Examples 9-13, wherein executing performance testing on the optimized source code comprises comparing values of one or more key performance indicators to corresponding thresholds.

Example 15: The computer-implemented method of any of Examples 9-14, wherein the key performance indicator driven code analysis comprise analyzing performance metrics including one or more of: response time, error rate, central processing unit usage, and memory usage.

Example 16: The computer-implemented method of any of Examples 9-15, wherein the large language model comprises ChatGPT.

Example 17: A non-transitory computer-readable medium storing instructions, which when executed by at least one processor, result in operations comprising:
receiving execution data associated with a user interacting with an application programming interface through a user interface on a computing device;
generating trace data based on the execution data, wherein the trace data indicates that a performance of an application is degraded;
generating one or more performance prompts specifying program behavior;
sending application source code and the performance prompts to an artificial intelligence engine for performing key performance indicator driven code analysis, the one or more performance prompts having been executed in the artificial intelligence engine for pretraining a large language model;
receiving, from the artificial intelligence engine, optimized source code based on the artificial intelligence engine performing the key performance indicator driven code analysis;
executing performance testing on the optimized source code; and
performing an action to address the performance of the application.

Example 18: The non-transitory computer-readable medium of Example 17, wherein the application programming interface is associated with an entity manipulation language application.

Example 19: The non-transitory computer-readable medium any of Examples 17-18, wherein the application programming interface is associated with a simple object access protocol.

Example 20: The non-transitory computer-readable medium any of Examples 17-19, wherein the trace data comprises one or more of: a database trace and a transaction analysis trace.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one processor; and
at least one memory storing instructions, which when executed by the at least one processor, result in operations comprising:
receiving execution data associated with a user interacting with an application programming interface through a user interface on a computing device;
generating trace data based on the execution data, wherein the trace data indicates that a performance of an application is degraded;
generating one or more performance prompts specifying program behavior;
sending application source code and the performance prompts to an artificial intelligence engine for performing key performance indicator driven code analysis, the one or more performance prompts having been executed in the artificial intelligence engine for pretraining a large language model;
receiving, from the artificial intelligence engine, optimized source code based on the artificial intelligence engine performing the key performance indicator driven code analysis;
executing performance testing on the optimized source code; and
performing an action to address the performance of the application.

2. The system of claim 1, wherein the application programming interface is associated with an entity manipulation language application.

3. The system of claim 1, wherein the application programming interface is associated with a simple object access protocol.

4. The system of claim 1, wherein the trace data comprises one or more of: a database trace and a transaction analysis trace.

5. The system of claim 1, wherein generating the trace data comprises generating one or more graphs corresponding to a performance of the application.

6. The system of claim 1, wherein executing performance testing on the optimized source code comprises comparing values of one or more key performance indicators to corresponding thresholds.

7. The system of claim 1, wherein the key performance indicator driven code analysis comprise analyzing performance metrics including one or more of: response time, error rate, central processing unit usage, and memory usage.

8. The system of claim 1, wherein the large language model comprises ChatGPT.

9. A computer-implemented method comprising:
receiving execution data associated with a user interacting with an application programming interface through a user interface on a computing device;
generating trace data based on the execution data, wherein the trace data indicates that a performance of an application is degraded;
generating one or more performance prompts specifying program behavior;
sending application source code and the performance prompts to an artificial intelligence engine for performing key performance indicator driven code analysis, the one or more performance prompts having been executed in the artificial intelligence engine for pretraining a large language model;
receiving, from the artificial intelligence engine, optimized source code based on the artificial intelligence engine performing the key performance indicator driven code analysis;
executing performance testing on the optimized source code; and
performing an action to address the performance of the application.

10. The computer-implemented method of claim 9, wherein the application programming interface is associated with an entity manipulation language application.

11. The computer-implemented method of claim 9, wherein the application programming interface is associated with a simple object access protocol.

12. The computer-implemented method of claim 9, wherein the trace data comprises one or more of: a database trace and a transaction analysis trace.

13. The computer-implemented method of claim 9, wherein generating the trace data comprises generating one or more graphs corresponding to a performance of the application.

14. The computer-implemented method of claim 9, wherein executing performance testing on the optimized source code comprises comparing values of one or more key performance indicators to corresponding thresholds.

15. The computer-implemented method of claim 9, wherein the key performance indicator driven code analysis comprise analyzing performance metrics including one or more of: response time, error rate, central processing unit usage, and memory usage.

16. The computer-implemented method of claim 9, wherein the large language model comprises ChatGPT.

17. A non-transitory computer readable medium storing instructions, which when executed by at least one processor, result in operations comprising:
receiving execution data associated with a user interacting with an application programming interface through a user interface on a computing device;
generating trace data based on the execution data, wherein the trace data indicates that a performance of an application is degraded;
generating one or more performance prompts specifying program behavior;
sending application source code and the performance prompts to an artificial intelligence engine for performing key performance indicator driven code analysis, the one or more performance prompts having been executed in the artificial intelligence engine for pretraining a large language model;
receiving, from the artificial intelligence engine, optimized source code based on the artificial intelligence engine performing the key performance indicator driven code analysis;
executing performance testing on the optimized source code; and
performing an action to address the performance of the application.

18. The non-transitory computer readable medium of claim 17, wherein the application programming interface is associated with an entity manipulation language application.

19. The non-transitory computer readable medium of claim 17, wherein the application programming interface is associated with a simple object access protocol.

20. The non-transitory computer readable medium of claim 17, wherein the trace data comprises one or more of: a database trace and a transaction analysis trace.
